(19) United States
(12) Patent Application Publication
(10) Pub. No.: US 2004/0053037 A1
(43) Pub. Date: Mar. 18, 2004

(54) Layer by layer assembled nanocomposite barrier coatings

(76) Inventors: Carol A. Koch, San Gabriel, CA (US); Jay R. Akhave, Claremont, CA (US); Rishikesh K. Bharadwaj, Arcadia, CA (US)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/439,718

(22) Filed: May 16, 2003

Related U.S. Application Data
(60) Provisional application No. 60/411,003, filed on Sep. 16, 2002.
(60) Provisional application No. 60/417,316, filed on Oct. 9, 2002.

(51) Int. Cl. B05D 3/02; B05D 1/36

(52) U.S. Cl. 428/323; 427/402; 427/372.2

(57) ABSTRACT

A multilayer barrier coating of alternating layers of an organic material and a negatively charged inorganic material. The barrier coating may be a barrier to oxygen, moisture, flavor and/or aroma. The organic material is deposited on a substrate from an aqueous solution, followed by rinsing and then drying the adsorbed layer of organic material. The negatively charged inorganic material is then deposited over the organic material from an aqueous solution, followed by rinsing and then drying the adsorbed layer of inorganic material.

This application claims the benefit of provisional applications No. 60/411,003 filed Sep. 16, 2002 and No. 60/417,316 filed Oct. 9, 2002.

### BACKGROUND OF THE INVENTION

This invention relates to a barrier coating constructed of alternating layers of an organic material and a negatively charged inorganic material that is applied to a film, package or article to prevent the penetration or permeation of vapors or gases to provide, for example, a moisture barrier, an oxygen barrier, and/or a flavor or aroma barrier.

The barrier properties of packaging films are often crucial for particular applications. For example, packaging for fruit juices must be impermeable to water and oxygen in order to assure the quality of the product. The optimal gas conditions for a product packed in a modified atmosphere packaging (MAP) are achieved by selecting a packaging material with a suitable oxygen and carbon dioxide permeability.

High barrier films produced by sputter coating or vacuum deposition of inorganic materials onto a substrate require complex and expensive equipment. The inflexible coating may be deposited onto a substrate, a film or an article. The resulting coatings tend to be brittle and crack easily, creating defects that significantly limit the barrier properties.

There is a need therefore, for a barrier film that is flexible, relatively easy and inexpensive to manufacture, and that provides exceptional barrier properties.

### SUMMARY OF THE INVENTION

The present invention relates to a multilayer barrier coating of alternating layers of an organic material and a negatively charged nanoscopic platelet material. In one embodiment, the multilayer barrier coating on a substrate comprises alternating layers of: at least one layer of a cationic polyelectrolyte; at least one layer of negatively charged nanoscopic platelets of inorganic material; wherein the cationic polyelectrolyte layer and the inorganic material layer are held together by ion exchange reaction.

In another embodiment, the multilayer barrier coating on a substrate comprises alternating layers of: at least one layer of a hydrogen bonding polymer; and at least one layer of negatively charged nanoscopic platelets of inorganic material.

The barrier coating may be an oxygen, gas, flavor and/or aroma barrier. In addition, the barrier coating may be a barrier to plasticizer migration or to migration of another chemical compound.

The organic material is deposited on a substrate from an aqueous solution, followed by rinsing and then drying the adsorbed layer of cationic material. The negatively charged inorganic material is then deposited over the cationic organic material from an aqueous solution, followed by rinsing and then drying the adsorbed layer of inorganic material. The deposition, rinsing, and drying steps are repeated until a multilayer coating having the desired barrier properties is obtained.

### BRIEF DESCRIPTION OF THE DRAWINGS

FIG. 1 is a cross-sectional view of the substrate and alternating layers of polyelectrolyte and inorganic particles on the substrate.

FIG. 2 is a cross-sectional view of the barrier coating of the present invention applied to a multilayer structure.

FIG. 3 is a cross-sectional view of the barrier coating of the present invention within a laminate structure.

FIG. 4 is an ellipsometric film thickness plot for the barrier coating of the present invention.

FIG. 5 is an ellipsometric film thickness plot showing the thickness of each layer of the barrier film.

### DETAILED DESCRIPTION OF THE INVENTION

Barrier Coating

As used herein, the term “barrier” means that the coating or film, or structure into which the coating or film is incorporated prevents the penetration or permeation of material through or beyond the coating or structure acting as the barrier. The barrier can be selective or non-selective, depending on whether the barrier acts to prevent a specific vapor or gas, liquid, or chemical compound to penetrate or permeate the barrier coating or structure. For example, an oxygen barrier would prevent penetration of oxygen, a moisture barrier would prevent penetration or permeation of water vapor, a flavor or aroma barrier would prevent penetration or permeation of organic molecules that impart flavor or aroma, a corrosion barrier would prevent penetration of moisture, acid or bases, or gases that promote corrosion. The present invention can be used to provide a hydrogen, helium and/or carbon dioxide barrier coating.

The barrier coating is sufficiently flexible so as to not crack, split or separate when the composite construction is bent or flexed during its normal use. The thickness of the barrier coating is sufficient to provide it with desired barrier properties.

In one embodiment, the barrier coating is made up of alternating layers of a cationic polyelectrolyte and a negatively charged inorganic material. In another embodiment, the barrier coating is made up of alternating layer of a hydrogen-bonding polymer and a negatively charged inorganic material. The number of alternating layers of the barrier coating depends on the barrier properties desired, as well as the composition of the substrate. The first approximately ten layers of each of the organic material and the inorganic material of the assembly are typically inhomogeneous with respect to surface coverage and ordering. In one embodiment, at least twenty of each of the cationic organic layer and the inorganic layer are deposited. In another embodiment, at least thirty of each of the cationic organic layer and the inorganic layer are deposited.

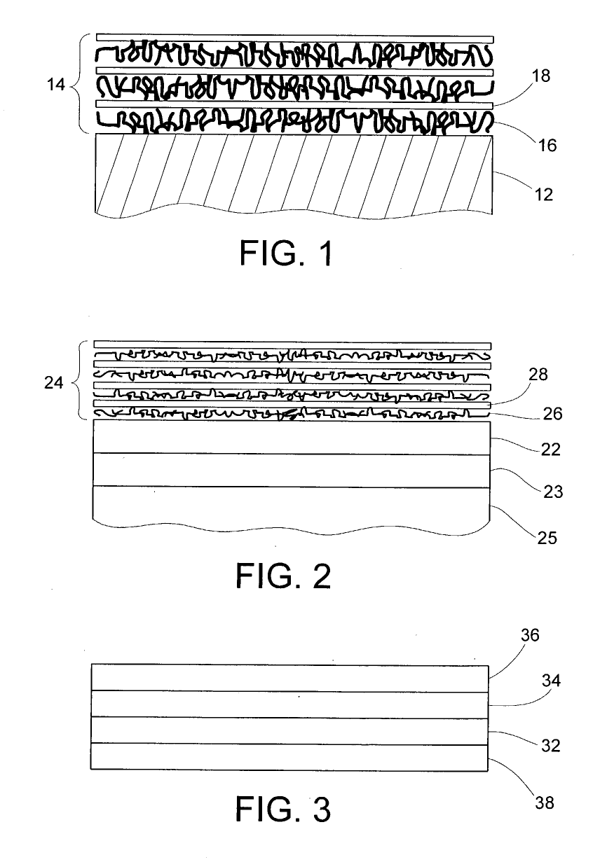

FIG. 1 illustrates the barrier film of the present invention, in which barrier coating 14 is deposited on substrate 12. Barrier coating 14 is made up of alternating layers of cationic polyelectrolyte 16 and negatively charged inorganic material 18.

The organic layer is deposited onto the substrate from a dilute solution, typically aqueous, of polymers. The polymers can include cationic polyelectrolytes or polymers capable of hydrogen bonding. Useful cationic polyelectrolytes include polydiallyldimethyl ammonium chloride (PDDA), polyallylamine hydrochloride, and copolymers containing quaternary ammonium acrylic monomers. Examples of quaternary ammonium acrylic monomers include methacryloxyethyltrimethyl ammonium chloride, acryloxyethyl dimethylbenzyl ammonium chloride, methacryloxyethyl dimethylbenzyl ammonium chloride and acryloxyethyltrimethyl ammonium chloride. Polymers capable of hydrogen bonding, or hydrogen donors include polyethyleneimine, polyvinylimidazole, polylysine, poly-N-methyl-N-vinylacetamide, polyvinylpyrrolidone, polyvinyl alcohol, polyacrylamide and copolymers of aminoacrylates. The polymers can also become cationic at low pH due to protonation. Copolymers of acrylamide and acryloxytrimethylammonium chloride are particularly useful.

Substituted acrylamides and methacrylamides may be included into the copolymer in relatively small amounts. In large amounts, substituted acrylamides and methacrylamides adversely affect the solubility of the polycation.

In one embodiment, the cationic copolymer comprises a copolymer of acrylamide monomer and acryloxyethyltrimethyl ammonium chloride. In another embodiment, the cationic copolymer comprises a cationic acrylamide commercially available from Cytec under the trade name Superfloc C-491. In yet another embodiment, the cationic copolymer comprises a cation-modified polyvinyl alcohol commercially available from Kuraray under the designation CM-318.

Cationic polyelectrolytes with a relatively low charge density have been found to provide better barrier properties than such polyelectrolytes with a higher charge density. As used herein, the charge density is the mole percentage of cationic monomer in the cationic polymer. The charge density of the cationic polymer is preferably less than 50%.

The inorganic material used in the composite barrier coating of the present invention comprises negatively charged platelets having a thickness of less than about 10 nanometers. Useful inorganic material includes platelet clays that are easily exfoliated in aqueous or polar solvent environments. The clays may be naturally occurring or synthetic. Platelet clays are layered crystalline aluminosilicates. Each layer is approximately 1 nanometer thick and is made up of an octahedral sheet of alumina fused to 2 tetrahedral sheets of silica. These layers are essentially polygonal two-dimensional structures, having a thickness of 1 nanometer and an average diameter ranging from 30 to 2000 nanometers. Isomorphic substitutions in the sheets lead to a net negative charge, necessitating the presence of cationic counter ions (Na+, Li+, Ca++, Mg++, etc.) in the inter-sheet region. The sheets are stacked in a face-to-face configuration with inter-layer cations mediating the spacing. The high affinity for hydration of these ions allows for the solvation of the sheet in an aqueous environment. At sufficiently low concentrations of platelets, for example less than 1% by weight, the platelets are individually suspended or dispersed in solution. This is referred to as “exfoliation”.

Particularly useful are clays belonging to the smectite family of clay, including montmorillonite, saponite, beidellite, nontronite, hectorite, laponite fluorohectorite and mixtures of these. A preferred clay is montmorillonite. This clay is usually present in a sodium ion exchange form. Montmorillonite clay is commercially available from Southern Clay Products, Inc. under the trade name Cloisite. In one embodiment, the clay comprises sodium montmorillonite.

Other useful inorganic materials in platelet form include layered titanates, including those within the chemical formula Ti_{1-δ}O₂^{4δ-}; layered perovskites, including HCa₂Nb₃O₁₀, HSrNb₃O₁₀, HLaNb₂O₇ and HCaLaNb₂TiO₁₀; and mica.

The inorganic material used in the multilayer coating must itself be impermeable to the vapor, gas or liquid to which the multilayer coating is used as a barrier.

Substrate

The substrate onto which the barrier coating is deposited may be any substrate that the cationic organic material can be adsorbed directly, or indirectly with the aid of an adhesion promoter or tie layer. The substrate may be a polymeric material, a metal, a ceramic material or crystalline material. In one embodiment, the substrate is optically transparent. The substrate may be rigid, or may be flexible. Examples of useful polymeric substrates include those selected from polyolefins (linear or branched), halogenated polyolefins, polyamides, polystyrenes, nylon, polyesters, polyester copolymers, polyurethanes, polysulfones, styrene-maleic anhydride copolymers, styrene-acrylonitrile copolymers, ionomers based on sodium or zinc salts of ethylene methacrylic acid, polymethyl methacrylates, cellulosics, acrylic polymers and copolymers, polycarbonates, polyacrylonitriles, and ethylene-vinyl acetate copolymers. Included in this group are the acrylates such as ethylene methacrylic acid, ethylene methyl acrylate, ethylene acrylic acid and ethylene ethyl acrylate. Also included in this group are polymers and copolymers of olefin monomers having, for example, 2 to about 12 carbon atoms, and in one embodiment, 2 to about 8 carbon atoms. These include the polymer of α-olefins having from 2 to about 4 carbon atoms per molecule. These include polyethylene, polypropylene, poly-1-butene, etc. Films prepared from blends of copolymers or blends of copolymers with homopolymers are also useful.

The substrate can be a single-layered film or it can be a multi-layered construction. FIG. 2 illustrates a barrier coated multilayer structure in which barrier coating 24, made up of alternating layers of cationic polyelectrolyte 26 and negatively charged inorganic material 28, is deposited onto first substrate layer 22. Second substrate layer 23 and third substrate layer 25 may be coextruded with layer 22. Alternatively, second substrate layer 23 and third substrate layer 25 may be laminated with an adhesive onto substrate layer 22.

The multi-layered constructions have two or more layers, and in one embodiment, about two to about seven layers, and in one embodiment about three to about five layers. The layers of such multi-layered constructions and polymer films can have the same composition and/or size or they can be different. The substrate can have any thickness that is suitable for the intended use of the barrier coated article. The thickness of the substrate may be in the range of about 0.3 to about 20 mils, and in one embodiment, about 0.3 to about 10 mils, and in one embodiment about 0.5 to about 7 mils, and in one embodiment about 1 to about 5 mils.

The substrate may be an untreated film that is amenable to adsorption. Alternatively, this film may be treated by first exposing the film to an electron discharge treatment at the surface, e.g., corona treatment. Other surface treatments to enhance the adsorption of the cationic organic material are well known. For example, the surface of the substrate may be plasma treated, chemically treated or solvent washed. Additionally, polymeric films that have been pretreated to promote adhesion are commercially available. Examples of such pretreated films include the PET films available from DuPont Teijin Films under the designations ST504 (one side treated) and ST505 (both sides treated).

The barrier coating may be incorporated into a laminate structure, such as that illustrated in FIG. 3. In this embodiment, barrier layer 34 is deposited onto substrate 32. Top layer 36 can then be applied over barrier layer 34 by any method, including but not limited to deposition, lamination, roll coating, die coating, rotogravure coating or flexographic coating. Top layer 36 may comprise, for example, an abrasion-resistant layer, a UV protection layer, an ink-receptive layer, etc. Layers 32 and 38 together may comprise a coextruded multilayer substrate. Alternatively, layer 38 may be laminated to substrate layer 32 by an adhesive.

In one embodiment, the barrier film is coated onto a laminate structure made up of at least two films laminated together with an adhesive layer. The coated laminate structure can be separated into two films, each having a barrier coating on one of its major surfaces.

In one embodiment, the barrier film is deposited onto a carrier film that can be subsequently removed. For example, after depositing the barrier film onto a carrier film, the exposed surface of the barrier film is laminated or adhered to another substrate, after which the carrier film is removed from the barrier film. The carrier film may comprise a flexible film such as, for example, polypropylene.

In yet another embodiment, two or more films, each having a barrier coating on one or both of its major surfaces, are laminated together to form a laminate structure having multiple barrier coatings.

In one aspect of the invention, the multilayer barrier coating is an oxygen barrier. The oxygen barrier coating reduces the transmission of oxygen through the film onto which it is coated. For example, in one embodiment, the oxygen transmission rate for the multilayer barrier coated film is less than 10% of the oxygen transmission of the uncoated film. The oxygen transmission rate of the multilayer barrier coated film in one embodiment is less than 1.0 cc/m²·day, and in another embodiment, less than 0.005 cc/m²·day.

Process

The process for making the barrier coating of the present invention comprises the steps of (1) dipping the substrate into an aqueous cationic polyelectrolyte solution, (2) drying the deposited cationic polymer, (3) dipping the substrate into an aqueous solution of inorganic particles, (4) rinsing the substrate with water, (5) drying the layer of cationic polymer (6) dipping the substrate into an aqueous cationic polyelectrolyte solution, (7) rinsing the substrate with water, (8) drying the deposited cationic polymer, (9) dipping the substrate into an aqueous solution of inorganic particles, (10) rinsing the substrate with water, (11) drying the layer of inorganic particles (12) repeating the steps 6-11 to produce a multilayer barrier film on the substrate. The aqueous solutions of step 6 can be the same as, or different than the solutions used in steps 1-4. The multilayer barrier coating may consist of different layers of cationic polymer and different layers of inorganic particles. In one embodiment, a polar solvent other than water is used to deposit the organic material and to rinse the deposited layer.

Prior to dipping the substrate into the aqueous cationic polyelectrolyte solution, the substrate may be rinsed with methanol and then washed with water. Optionally, the substrate may be surface treated to improve the adhesion of the cationic polymer layer.

In one embodiment, the aqueous cationic polyelectrolyte solution comprises a solution of about 0.07% to about 1.5% by weight of cationic polymer. In one embodiment, the cationic polyelectrolyte solution comprises a solution of about 1.0% by weight of cationic polymer. The thickness of each organic polymer layer is generally less than about 50 nanometers. In one embodiment, the thickness is less than about 30 nanometers. In one embodiment, the thickness is of each organic layer is within the range of about 5 nanometers to about 45 nanometers. In another embodiment, the thickness of each organic layer is within the range of about 15 nanometers to about 30 nanometers.

The aqueous solution of inorganic particles generally comprises less than 1% by weight of inorganic particles. In one embodiment, the aqueous solution of inorganic particles comprises about 0.05% by weight of inorganic particles. The thickness of each inorganic layer is generally less than 10 nanometers. In one embodiment, the thickness is less than about 5 nanometers. In one embodiment, the thickness of each inorganic layer is within the range of about 1 nanometer to about 10 nanometers. In one embodiment, the thickness of each inorganic layer is within the range of about 1 to about 7 nanometers, and in another embodiment, the thickness of each inorganic layer is within the range of about 1.5 to about 5.

The immersion time of the substrate in each of the coating solutions may be varied according to the particular coating solution, substrate composition, coating composition, or desired coating properties. The substrate may be held stationary in the coating solution, or the substrate may be moved within the coating solution bath, or may be continuously moved through the coating solution bath, for example, as a moving web of substrate material.

### EXAMPLE 1

Preparation of Cationic Organic Solution:

Acrylamide monomer (51.64 g) and acryloxyethyltrimethylammonium chloride (1.836 g) are dissolved in deionized water (301.469 g) and transferred to a one-liter glass-walled reactor and purged with nitrogen while stirring. The reactor is heated to 30° C. and the following is added: ammonium persulfate (0.0679 g) in deionized water (5.43 g) and sodium metabisulfite (0.0591 g) in deionized water (5.00 g). An exotherm occurs in about 5 min., increasing the temperature to 52° C. The reaction is maintained at 50° C. for 2 hours, at which time an additional amount of catalyst is added: ammonium persulfate (0.0666 g) in deionized water (6.83 g) and sodium metabisulfite (0.0420 g) in deionized water (6.39 g). The temperature is kept at 50° C. for another hour and then the reactor is cooled. Analysis by liquid chromatography shows very low residual monomers, <50 ppm acrylamide and <100 ppm acryloxyethyltrimethylammonium chloride. The polymer is precipitated in acetone and dried, then redissolved in ultrapure water, <18 megaohms, at a concentration of 1.1 to 1.4 weight %.

Preparation of Inorganic Solution:

Sodium montmortillonite (0.3961 g), available as Cloisite Na+ from Southern Clay Products, is dissolved in ultrapure water (765.98 g) and stirred resulting in a slightly hazy solution. The solution is allowed to stand for at least 24 hours before use.

Preparation of Barrier Coating:

A 2 inch by 4 inch sheet of 5 mil thick PET film (ST504 from DuPont Teijin Films) with one side adhesion treatment is rinsed with methanol and then washed with water. The film is dipped in the polycation solution for 10 minutes, and then dried under a stream of nitrogen. The film is dipped in the inorganic solution for 10 minutes, rinsed with water and then dried under a stream of nitrogen. Successive layers of polycation and inorganic material are deposited in the same manner, except that the dip time is reduced to 1 minute. The composite is rinsed with water after each layer. Forty layers each of polycation and inorganic material are deposited on both sides of the film.

Table 1 below shows the oxygen transmission rate (OTR) of the PET substrate with the barrier coating of Example 1. The helium transmission rate of a PET substrate with the barrier coating of Example 1 at 23° C. and dry conditions is 93 cc/m²day as measured on a MOCON Multi-Tran 400. The hydrogen transmission rate of a PET substrate with the barrier coating of Example 1 at 23° C. and dry conditions is 20.0 cc/m²day as measured on a MOCON Multi-Tran 400. The carbon dioxide transmission rate of a PET substrate with the barrier coating of Example 1 at 23° C. and dry conditions is less than 1.0 cc/m²day as measured on a MOCON Permatran C4/40.

The contact angle of water on the barrier coating of Example 1 is 22.3° and the contact angle of tricresylphosphate (TCP) on the barrier coating of Example 1 is 17.3°. These values are used to determine the total surface energy of the barrier film of Example 1 of 67.9 mN/M and a polar component of 42.6 mN/m.

The elemental surface composition of the barrier coating of Example 1 evaluated by x-ray photoelectron spectroscopy is 50.1% carbon, 14.1% nitrogen, 27.8% oxygen, 1.4% aluminum and 6.6% silicon.

### EXAMPLES 2-23

Examples 2-23 are prepared according to the method described above with regard to Example 1, with the number of sequential layers and substrate as indicated in Table 1 below.

TABLE 1

| | | Thickness | OTR Uncoated | OTR Barrier Film | Number of |
|---|---|---|---|---|---|
| Example | Film | (mils) | Film (cc/m² day) | (cc/m² day) | Layers |
| 1 | ST504 | 5 | 13.2 | <0.005 | 40 |
| 2 | STS04 | 5 | 13.2 | 0.6 | 20 |
| 3 | STS04 | 5 | 13.2 | 1.6 | 10 |
| 4 | ST505 | 7 | 10.7 | <0.005 | 30 |
| 5 | ST505 | 7 | 10.7 | <0.005 | 40 |
| 6 | ST505 | 7 | 10.7 | <0.005 | 80 |
| 7 | Arylite¹ | 4 | 2700 | <0.005 | 40 |
| 8 | Arton² | 8 | 348 | <0.005 | 100 |
| 9 | Arton | 7 | 765 | 0.34 | 40 |
| 10 | SiOx/PET³ | 7 | 8.18 | <0.005 | 60 |
| 11 | Mylar D | 2 | 28.1 | <0.005 | 40 |
| 12 | Mylar LJX111 | 4 | 25.3 | 0.23 | 40 |
| 13 | SMLPP⁴ | 6 | 364 | 5.48 | 80 |
| 14 | Plylene⁵ | 4 | 49.4 | 1.39 | 40 |
| 15 | PCTFE⁶ | 2 | 33 | 0.15 | 40 |
| 16 | Barex⁷ | 2 | 4.6 | <0.005 | 30 |
| 17 | calendered | 3 | 472 | 11.7 | 40 |
| | vinyl | | | | |
| 18 | Pvc | 10.6 | 19 | ’10.005 | 40 |
| 19 | LLDPE⁸ | 2 | >2000 | 152 | 40 |
| 20 | nylon | 0.7 | 5 | <0.005 | 40 |
| 21 | nylon | 5 | 8 | <0.005 | 40 |
| 22 | biaxially | 0.6 | 54 | 0.03 | 40 |
| | oriented nylon | | | | |
| 23 | biaxially | 0.6 | 54 | 0.12 | 20 |
| | oriented nylon | | | | |

¹polyacrylate from Ferrania
²norbornene from Lintec
³from Sheldahl
⁴polypropylene from SML
⁵multilayer coextruded film of nylon and LLDPE from Pliant
⁶polychlorotrifluoroethylene
⁷acrylonitrile methyl acrylate copolymer from BP
⁸linear low density polyethylene

Oxygen Transmission Rate:

Oxygen transmission rate, OTR, is measured using a MOCON OX-TRAN 2/20 (ML System) at 23° C. and dry conditions (<2% relative humidity) according to ASTM D3985. The lower detection limit of the instrument is 0.005 cc/m²·day. The OTR of samples measuring 2 inches by 4 inches is determined by applying a double foil mask with a 5 cm² opening to the sample and using the MOCON OX-TRAN 2/20. The OTR of samples measuring 3.5 inches by 4 inches are measured without the foil mask. The OTR of various samples are independently measured by MOCON using the Super Oxtran system in which the instrument is enclosed in a nitrogen environment to improve the detection limit of the instrument.

Moisture Vapor Transmission Rate

The moisture barrier properties of the various barrier coatings are measured at 40° C. and high humidity (90% or 100% relative humidity) using the method of ASTM F1249. Table 2 below shows the moisture vapor transmission rate (MVTR) for the barrier coatings.

Thickness

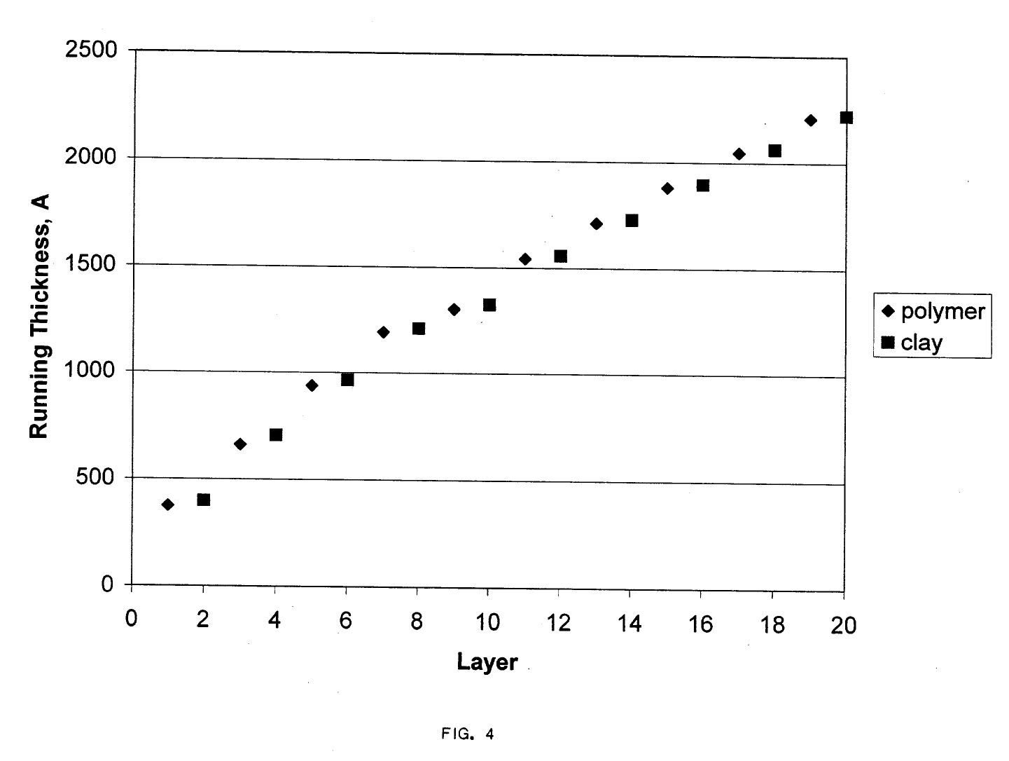

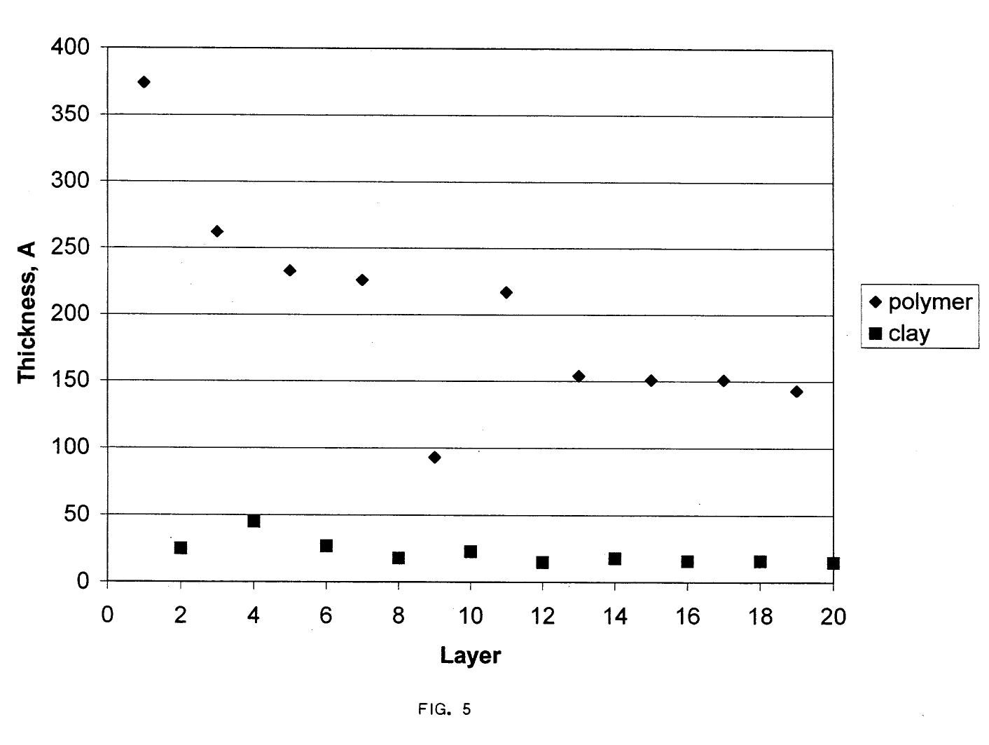

An analysis of the thickness of the barrier coating is conducted by ellipsometry. FIG. 4 shows the increasing thickness of the barrier coating as additional layers are deposited. FIG. 5 shows the thickness of the individual clay layers and individual polyelectrolyte layers. The ellipsometry data indicates an average clay layer of about 2 nanometers and an average polymer layer of about 20 nanometers.

Flex Crack Resistance:

A mandrel test, in which a sample measuring 3.5 inches by 4 inches is bent around a ⅝ inch mandrel 100 times and left wrapped around the mandrel for 72 hours at room temperature is used to measure the flex crack resistance. The OTR is measured before and after subjecting the sample to the mandrel test. The OTR of the barrier coating of Example 1 is remeasured after subjecting the sample to the mandrel test and found to remain below the detection limit of 0.005 cc/m²·day.

Light Transmission:

A BYK Gardner Hazemeter is used to measure transmittance, haze and clarity and compared to the uncoated substrate. The uncoated ST504 PET film has a transmittance of 92.0%, haze of 0.96%, and clarity of 99.8%. Six individual samples are measured for the coating of Example 1 on an ST504 PET film to obtain an average transmittance of 93.92±0.37 (6,0.35), haze of 1.88±0.47 (6,0.45) and clarity of 99.13±0.49 (6, 0.47).

Cross Hatch Adhesion Test:

Adhesion of the coating to the underlying substrate is measured using ASTM D 3359-93, Test Method B. Eleven cuts through the coating of Example 1 are made in two directions, a tape is applied and peeled away immediately 180° from the substrate. The area is then examined to determine whether the coating has been removed. Three different types of tape are used, 3M® 810, 3M® 600 and FASSON® Crystal Clear. None of the barrier coating is removed for each tape used.

TABLE 2

| | | | MVTR Uncoated | MVTR Barrier | |
|---|---|---|---|---|---|
| | | | Film | Film | |
| | | Thickness | 100% RH | 100%RH | |
| Example | Film | (mils) | (cg/m2day) | (cg/m2day) | Number of Layers |
| 1 | ST504 | 5 | 6.06 | 5.17* | 40 |
| 4 | ST505 | 7 | 4.46 | 345* | 30 |
| 7 | ARYLITE | 4 | 120 | 86 | 40 |
| 8 | ARTON | 8 | 31.4 | 21.8 | 100 |
| 9 | ARTON | 7 | 35.1 | 26 | 40 |
| 10 | SiOx/PET | 7 | 4.34 | 3.88 | 60 |
| 11 | MylarD | 2 | 13.8 | 943* | 40 |
| 12 | Mylar | 4 | 9.19 | 7.62 | 40 |
| | LJX111 | | | | |
| 13 | SMLPP | 6 | 1.99 | 1.14* | 80 |
| 14 | Plyene | 4 | 5.55 | 6.27* | 40 |

*tested at 90% relative humidity

Flavor Permeation

Flavor permeation testing is conducted on samples of the barrier coating of Example 5 using limonene, menthol and anethole to simulate flavor permeability. The tests are conducted at 49° C. and dry conditions with the paste not in contact with the film. The results demonstrate an average transmission rate of 105 μg/m²·d for limonene, 51 μg/m²·d for menthol and <

10 μg/m²·d for anethole.

### EXAMPLE 24

The barrier coated film of Example 1 is coated on one side with 4 layers of polyvinyl dichloride (PVDC) at an approximate total thickness of 0.5 mil. The multilayer composite exhibits an OTR of 0.48 cc/m²·day at 23° C. and 90% relative humidity. The coated sample also exhibits no increase in OTR with increasing temperature. The OTR at 40° C. and dry conditions is <0.005 cc/m²·day.

### EXAMPLE 25

A barrier coating on PET film ST505 is prepared substantially in accordance with the procedure described in Example 1, with the exception that the cationic polymer used is an acrylamide copolymer available from Cytec under the trade name Superfloc C-491. Sixty layers each of acrylamide copolymer and montmorillonite are deposited on both sides of the film. The OTR at 23° C. and dry conditions (<2% relative humidity) is <0.005 cc/m²·day.

### EXAMPLE 26

A barrier coating on PET film ST505 is prepared substantially in accordance with the procedure described in Example 1, with the exception that the cationic polymer used is a cationically modified polyvinyl alcohol polymer available from Kuraray under the trade name CM-318. Forty layers each of polyvinyl alcohol polymer and montmorillonite are deposited on both sides of the film. The OTR at 23° C. and dry conditions (<2% relative humidity) is <0.005 cc/m²·day.

### EXAMPLE 27

A barrier coating on PET film ST505 is prepared substantially in accordance with the procedure described in Example 1, with the exception that the organic material used is a hydrogen-bonding material, Superfloc N-300, a homopolymer of acrylamide (0.25% by wt.). Forty layers each of the hydrogen bonding material and montorillonite are deposited on both sides of the film. The OTR at 23° C. and dry conditions is <0.005 cc/m²·day.

### EXAMPLE 28

A barrier coating prepared substantially in accordance with the procedure described in Example 1 is coated onto a laminate structure of two sheets of ST505 laminated together with a pressure sensitive transfer tape. The barrier coating is made up of 60 layers. The two sheets are separated and the adhesive removed with hexane, resulting in two sheets having a barrier coating on one surface. The oxygen transmission rate (OTR) for each of the sheets following separation is <0.005 cc/m²·day.

### EXAMPLE 29

Two PCTFE films, each having a 40 layer barrier coating prepared substantially in accordance with the procedure of Example 1 coated onto its front and back surfaces are laminated together using a pressure sensitive adhesive transfer tape. The OTR, measured at 23° C. and 90% relative humidity, for the laminate structure is <0.005 cc/m²·day, compared to 31.7 cc/m²·day for each of the individual coated films. The MVTR, measured at 38° C. and 90% humidity is 0.01 g/m²·day, compared to 0.07 g/m²·day for the individual coated films.

### EXAMPLE 30

Prior to coating with the barrier coating of Example 1, an LLDPE film is corona treated. The corona treated coated film has an OTR of 61 cc/m²·day, compared to the film of Example 19 having an OTR of 152 cc/m²·day.

### EXAMPLE 31

Prior to coating with the barrier coating of Example 1, a PCTFE film is plasma treated. The plasma treated coated film has an OTR of 0.09 cc/m²·day, compared to the film of Example 15 having an OTR of 0.15 cc/m²·day.

Although the invention has been shown and described with respect to a certain embodiment or embodiments, it is obvious that equivalent alterations and modifications will occur to others skilled in the art upon the reading and understanding of this specification. In particular regard to the various functions performed by the above described elements (components, assemblies, compositions, etc.), the terms used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A multilayer barrier coating on a substrate comprising alternating layers of:
at least one layer of organic material;
at least one layer of negatively charged nanoscopic platelets of inorganic material; wherein the thickness of the organic material layer is less than about 50 nanometers and the thickness of the inorganic material layer is less than about 10 nanometers.

2. The multilayer barrier coating of claim 1 wherein the organic material comprises a cationic polyelectrolyte.

3. The multilayer barrier coating of claim 1 wherein the organic material comprises a polyacrylamide copolymer.

4. The multilayer barrier coating of claim 2 wherein the cationic polyelectrolyte comprises a copolymer of polyacrylamide and acryloxyethyltrimethyl ammonium chloride.

5. The multilayer barrier coating of claim 1 wherein the organic material comprises a hydrogen bonding polymer.

6. The multilayer barrier coating of claim 5 wherein the hydrogen bonding polymer comprises a homopolymer of acrylamide.

7. The multilayer barrier coating of claim 1 wherein the organic material comprises a polyvinylalcohol copolymer.

8. The multilayer barrier coating of claim 2 wherein the cationic polyelectrolyte has a charge density of less than 50%.

9. The multilayer barrier coating of claim 1 wherein the inorganic material comprises silicate clay, layered titanates or layered perovskites.

10. The multilayer barrier coating of claim 9 wherein the silicate clay is selected from the group consisting of montmorillonite, saponite, beidellite, nontronite, and hectorite clays.

11. The multilayer barrier coating of claim 9 wherein the inorganic material comprises sodium exchanged montmorillonite.

12. The multilayer barrier coating of claim 1 wherein the substrate comprises a polymeric film.

13. The multilayer barrier coating of claim 12 wherein the polymeric film is selected from polyolefins, halogenated polyolefins, polyamides, polystyrenes, nylon, polyesters, polyester copolymers, polyurethanes, polysulfones, styrene-maleic anhydride copolymers, styrene-acrylonitrile copolymers, ionomers based on sodium or zinc salts or ethylene methacrylic acid, polymethyl methacrylates, cellulosics, acrylic polymers and copolymers, polycarbonates, polyacrylonitriles and ethylene-vinyl acetate copolymers.

14. The multilayer barrier coating of claim 12 wherein the substrate comprises a flexible polymeric film.

15. The multilayer barrier coating of claim 12 wherein the substrate comprises a transparent polymeric film.

16. The multilayer barrier coating of claim 1 wherein the barrier coating is an oxygen barrier.

17. The multilayer barrier coating of claim 16 has an oxygen transmission rate of less than 1.0 cc/m²·day.

18. The multilayer barrier coating of claim 16 has an oxygen transmission rate of less than 0.005 cc/m²·day.

19. The multilayer barrier coating of claim 16 wherein the coating provides at least a ten fold reduction in oxygen transmission than an uncoated substrate.

20. The multilayer barrier coating of claim 1 wherein the barrier coating is a hydrogen barrier.

21. The multilayer barrier coating of claim 1 wherein the barrier coating is a helium barrier.

22. The multilayer barrier coating of claim 1 wherein the barrier coating is a carbon dioxide barrier.

23. The multilayer barrier coating of claim 1 wherein the barrier coating is flexible.

24. The multilayer barrier coating of claim 1 wherein the barrier coating is transparent.

25. The multilayer barrier coating of claim 1 wherein the thickness of the inorganic layer is less than about 5 nanometers.

26. The multilayer barrier coating of claim 1 wherein the thickness of the organic material layer is less than about 30 nanometers.

27. A barrier film comprising:
a substrate; and
a multilayer oxygen barrier coating comprising alternating layers of (a) at least one layer of organic material and (b) at least one layer of negatively charged nanoscopic platelets of inorganic material; wherein the thickness of the organic material layer is less than about 50 nanometers and the thickness of the inorganic material layer is less than about 10 nanometers; and
wherein the oxygen transmission rate of the barrier film is less than 10% of the oxygen transmission rate of the substrate.

28. A method for making a multilayer barrier coating on a substrate comprising the steps of:
(a) providing a substrate having a surface capable of adsorbing a an organic material;
(b) depositing a layer of organic material having a thickness of less than about 50 nanometers onto the surface of the substrate from an aqueous solution whereby a layer of organic material polyelectrolyte is adsorbed onto the substrate;
(c) drying the layer of organic material on the substrate;
(d) depositing a layer of negatively charged nanoscopic platelets of inorganic material having a thickness of less than about 10 nanometers onto the layer of organic material from an aqueous solution;
(e) rinsing the layer of inorganic material;
(f) drying the rinsed layer of inorganic material; and
(g) repeating the steps of (b)-(f) until a multilayer structure of alternating organic and inorganic material layers is formed having the desired barrier properties.

29. The method of claim 28 further comprising the step of rinsing the layer of organic material prior to drying the organic material.

30. The method of claim 29 further comprising the step of surface treating the substrate to make the substrate more receptive to adsorption of the organic material layer.

31. The method of claim 28 wherein the organic material comprises a cationic polyelectrolyte.

32. The method of claim 28 wherein the organic material comprises a polyacrylamide copolymer.

33. The method of claim 31.wherein the cationic polyelectrolyte comprises a copolymer of polyacrylamide and acryloxyethyltrimethyl ammonium chloride.

34. The method of claim 28 wherein the organic material comprises a hydrogen bonding polymer.

35. The method of claim 28 wherein the organic material comprises a polyvinylalcohol copolymer.

36. The method of claim 31 wherein the cationic polyelectrolyte has a charge density of less than 50%.

37. The method of claim 28 wherein the inorganic material comprises silicate clay, layered titanates or layered perovskites.

38. The method of claim 37 wherein the silicate clay is selected from the group consisting of montmorillonite, saponite, beidellite, nontronite, and hectorite clays.

39. The method of claim 38 wherein the inorganic material comprises sodium exchanged montmorillonite.

40. The method of claim 28 wherein the substrate comprises a polymeric film.

41. The method of claim 40 wherein the polymeric film is selected from polyolefins, halogenated polyolefins, polyamides, polystyrenes, nylon, polyesters, polyester copolymers, polyurethanes, polysulfones, styrene-maleic anhydride copolymers, styrene-acrylonitrile copolymers, ionomers based on sodium or zinc salts or ethylene methacrylic acid, polymethyl methacrylates, cellulosics, acrylic polymers and copolymers, polycarbonates, polyacrylonitriles and ethylene-vinyl acetate copolymers.

42. The method of claim 40 wherein the substrate comprises a flexible polymeric film.

43. The method of claim 40 wherein the substrate comprises a transparent polymeric film.

44. The method of claim 28 wherein the average thickness of each inorganic layer is less than about 5 nanometers.

45. The method of claim 28 wherein the average thickness of each organic layer is less than about 30 nanometers.
